(19) United States
(12) Patent Application Publication
(10) Pub. No.: US 2024/0427983 A1
(43) Pub. Date: Dec. 26, 2024

(54) INFORMATION PROCESSING APPARATUS, INFORMATION PROCESSING METHOD, AND STORAGE MEDIUM

(71) Applicant: NEC Corporation, Tokyo (JP)

(72) Inventors: Daichi HISADA, Tokyo (JP); Naotake FUJITA, Tokyo (JP)

(73) Assignee: NEC Corporation, Tokyo (JP)

(21) Appl. No.: 18/744,849

(22) Filed: Jun. 17, 2024

(30) Foreign Application Priority Data
Jun. 20, 2023 (JP) 2023-100956

(51) Int. Cl. G06F 40/166; G06F 40/20

(52) U.S. Cl. CPC G06F 40/166; G06F 40/20

(57) ABSTRACT

Provided is a work assistance technique having high accuracy. An information processing apparatus includes: a first acquisition means for acquiring instruction content and reference information which is to be referred to in a process indicated by the instruction content; a generation means for generating a prompt with reference to the instruction content and the reference information; and a second acquisition means for acquiring a generation sentence which has been generated based on the prompt.

This Nonprovisional application claims priority under 35 U.S.C. § 119 on Patent Application No. 2023-100956 filed in Japan on Jun. 20, 2023, the entire contents of which are hereby incorporated by reference.

### TECHNICAL FIELD

The present invention relates to an information processing apparatus, an information processing method, and a storage medium.

### BACKGROUND ART

Techniques to assist various kinds of tasks such as preparation and checking of documents are being developed. For example, Patent Literature 1 discloses a technique for checking a contract using a neural network which has been trained in advance.

### CITATION LIST

### Patent Literature

### [Patent Literature 1]

Japanese Patent Application Publication Tokukai No. 2020-166864

### SUMMARY OF INVENTION

### Technical Problem

Generally, accuracy is demanded in tasks such as preparation and checking of documents. However, the technique disclosed in Patent Literature 1 has a problem in terms of accuracy.

The present disclosure is accomplished in view of the above problem, and an example object thereof is to provide a work assistance technique having high accuracy.

### Solution to Problem

An information processing apparatus in accordance with an example aspect of the present disclosure includes at least one processor, the at least one processor carrying out: a first acquisition process of acquiring instruction content and reference information which is to be referred to in a process indicated by the instruction content; a generation process of generating a prompt with reference to the instruction content and the reference information; and a second acquisition process of acquiring a generation sentence which has been generated based on the prompt.

An information processing method in accordance with an example aspect of the present disclosure includes: acquiring, by at least one processor, instruction content and reference information which is to be referred to in a process indicated by the instruction content; generating, by the at least one processor, a prompt with reference to the instruction content and the reference information; and acquiring, by the at least one processor, a generation sentence which has been generated based on the prompt.

A storage medium in accordance with an example aspect of the present disclosure stores a program for causing a computer to carry out: a first acquisition process of acquiring instruction content and reference information which is to be referred to in a process indicated by the instruction content; a generation process of generating a prompt with reference to the instruction content and the reference information; and a second acquisition process of acquiring a generation sentence which has been generated based on the prompt.

### Advantageous Effects of Invention

According to the present disclosure, it is possible to provide a work assistance technique having high accuracy.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an information processing method in accordance with the present disclosure.

FIG. 3 is a block diagram illustrating a configuration of an information processing system in accordance with the present disclosure.

FIG. 4 is a flowchart illustrating a flow of an information processing method in accordance with the present disclosure.

FIG. 5 is a diagram for describing a prompt generation and generation sentence acquisition process in accordance with the present disclosure.

FIG. 6 is a diagram for describing a prompt generation and generation sentence acquisition process in accordance with the present disclosure.

FIG. 7 is a flowchart illustrating a flow of an information processing method in accordance with the present disclosure.

FIG. 8 is a diagram for describing a prompt generation and generation sentence acquisition process in accordance with the present disclosure.

FIG. 9 is a diagram for describing a prompt generation and generation sentence acquisition process in accordance with the present disclosure.

FIG. 10 is a flowchart illustrating a flow of an information processing method in accordance with the present disclosure.

FIG. 11 is a diagram for describing a prompt generation and generation sentence acquisition process in accordance with the present disclosure.

FIG. 12 is a diagram for describing a prompt generation and generation sentence acquisition process in accordance with the present disclosure.

FIG. 13 is a block diagram illustrating a configuration of an information processing system in accordance with the present disclosure.

FIG. 14 is a flowchart illustrating a flow of an information processing method in accordance with the present disclosure.

FIG. 15 is a block diagram illustrating a hardware configuration of an information processing apparatus in accordance with the present disclosure.

### EXAMPLE EMBODIMENTS

The following description will discuss an example embodiment of the present invention. Note, however, that the present invention is not limited to example embodiments described below, but may be altered in various ways by a skilled person within the scope of the claims. For example, the present invention can also encompass, in its scope, any example embodiment derived by appropriately combining technical means employed in the example embodiments described below. Alternatively, the present invention also encompasses, in its scope, any example embodiment derived by appropriately omitting part of technical means employed in the example embodiments described below. The example advantages described in each of the example embodiments below are example advantages expected in that example embodiment, and do not define an extension of the present invention. That is, the present invention also encompasses, in its scope, any example embodiment that does not bring about the example advantages described in the example embodiments below.

### First Example Embodiment

The following description will discuss a first example embodiment, which is an example of an embodiment of the present invention, in detail, with reference to the drawings. The present example embodiment is a basic form of example embodiments described later. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Information Processing Apparatus 1)

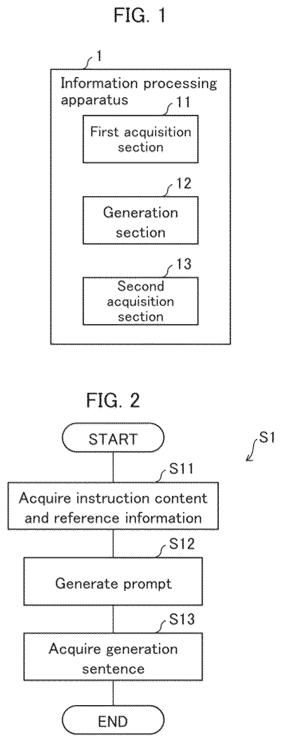

The following description will discuss a configuration of an information processing apparatus 1 in accordance with the present example embodiment, with reference to FIG. 1. FIG. 1 is a block diagram illustrating a configuration of the information processing apparatus 1. As illustrated in FIG. 1, the information processing apparatus 1 includes a first acquisition section 11, a generation section 12, and a second acquisition section 13.

### (First Acquisition Section 11)

The first acquisition section 11 acquires instruction content and reference information which is to be referred to in a process indicated by the instruction content, and provides the acquired instruction content and reference information to the generation section 12 (described later). For example, the first acquisition section 11 acquires an instruction from a user, and identifies instruction content with reference to wording included in the instruction. Alternatively, it is possible to employ a configuration in which the first acquisition section 11 acquires information indicating selection by a user in regard to an instruction, and identifies instruction content with reference to the information.

As the reference information acquired by the first acquisition section 11, it is possible to use, for example, information selected such that accuracy of a generation sentence is improved which is generated by a language model with reference to a prompt generated by the generation section 12 (described later). Note, however, that the present example embodiment is not limited to this. The expression “information which is to be referred to” in the above description does not limit the present example embodiment, and may be expressed simply as “referred information”. Specific content of the instruction content and the reference information does also not limit the present example embodiment. Examples of the instruction content and the reference information include, for example, the following.

### Example 1

The instruction content includes an instruction to evaluate an evaluation target, and the reference information includes past evaluation information which indicates evaluation in the past pertaining to the evaluation target.

### Example 2

The instruction content includes an instruction to analyze an analysis target, and the reference information includes first type viewpoint information indicating one or more analysis viewpoints in an analysis process.

### Example 3

The instruction content includes an instruction to check a check target, and the reference information includes comparative information which is to be compared with the check target in a checking process.

### (Generation Section 12)

The generation section 12 generates a prompt with reference to the instruction content and the reference information which have been acquired by the first acquisition section 11. Here, the prompt generated by the generation section 12 is a prompt to be input into a language model (described later), and the language model generates a generation sentence (described later) with reference to content of the prompt. A specific configuration of the prompt generated by the generation section 12 does not limit the present example embodiment. For example, it is possible to employ a configuration in which the generation section 12 generates the prompt including the instruction content and the reference information. The prompt generated by the generation section 12 is a prompt including a natural sentence. Note, however, that the present example embodiment is not limited thereto.

### (Second Acquisition Section 13)

The second acquisition section 13 acquires a generation sentence which has been generated based on the prompt generated by the generation section 12. More specifically, the second acquisition section 13 acquires a sentence (hereinafter simply referred to also as “generation sentence”) which has been generated by a language model upon receipt of input of the prompt generated by the generation section 12. Here, the language model may be a language model that is executed inside the information processing apparatus 1 or may be a language model that is executed by a generation apparatus which is communicably connected to the information processing apparatus 1. The language model is, for example, a language model which generates a generation sentence as a natural sentence with reference to a prompt including a natural sentence, and which has been subjected to machine learning in advance. Note, however, that the present example embodiment is not limited thereto.

### (Example Advantage of Information Processing Apparatus 1)

As described above, the information processing apparatus 1 employs the configuration of: acquiring instruction content and reference information which is to be referred to in a process indicated by the instruction content; generating a prompt with reference to the instruction content and the reference information; and acquiring a generation sentence which has been generated based on the prompt. Therefore, according to the information processing apparatus 1, it is possible to provide a work assistance technique having high accuracy.

### (Flow of Information Processing Method S1)

The following description will discuss a flow of an information processing method S1 in accordance with the present example embodiment, with reference to FIG. 2. FIG. 2 is a flowchart illustrating the flow of the information processing method S1. As illustrated in FIG. 2, the information processing method S1 includes step (process) S11 of acquiring instruction content and reference information, step (process) S12 of generating a prompt, and step (process) S13 of acquiring a generation sentence.

### (Step S11)

In step S11, the first acquisition section 11 acquires instruction content and reference information which is to be referred to in a process indicated by the instruction content, and provides the acquired instruction content and reference information to the generation section 12. The specific description pertaining to the first acquisition section 11 is described above, and is therefore omitted here.

### (Step S12)

In step S12, the generation section 12 generates a prompt with reference to the instruction content and the reference information which have been acquired by the first acquisition section 11. The specific process pertaining to the generation section 12 is described above, and therefore a description thereof is omitted here.

### (Step S13)

In step S13, the second acquisition section 13 acquires a generation sentence which has been generated based on the prompt generated by the generation section 12 in step S12. The specific description pertaining to the second acquisition section 13 is described above, and is therefore omitted here.

### (Example Advantage of Information Processing Method S1)

As described above, the information processing method S1 employs the configuration of: acquiring instruction content and reference information which is to be referred to in a process indicated by the instruction content; generating a prompt with reference to the instruction content and the reference information; and acquiring a generation sentence which has been generated based on the prompt. Therefore, according to the information processing method S1, it is possible to provide a work assistance technique having high accuracy.

### Second Example Embodiment

The following description will discuss a second example embodiment, which is an example of an embodiment of the present invention, in detail, with reference to the drawings. The same reference numerals are given to constituent elements having the same functions as those described in the foregoing example embodiment, and descriptions of such constituent elements are omitted as appropriate. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Information Processing System 1A)

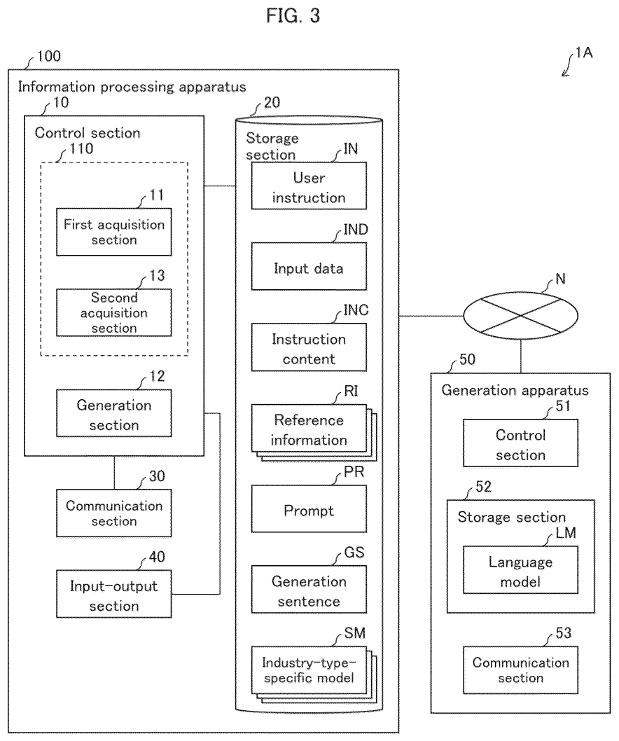

The following description will discuss a configuration of an information processing system 1A in accordance with the present example embodiment, with reference to FIG. 3. FIG. 3 is a block diagram illustrating the configuration of the information processing system 1A. As illustrated in FIG. 3, the information processing system 1A includes an information processing apparatus 100 and a generation apparatus 50 that is connected to the information processing apparatus 100 via a network N. A specific configuration of the network N does not limit the present example embodiment, and the network N is, for example, a wireless local area network (LAN), a wired LAN, a wide area network (WAN), a public network, a mobile data communication network, or a combination of these networks.

### (Generation Apparatus 50)

As illustrated in FIG. 3, the generation apparatus 50 includes a control section 51, a storage section 52, and a communication section 53. The communication section 53 communicates with an apparatus external to the generation apparatus 50. For example, the communication section 53 communicates with the information processing apparatus 100 included in the information processing system 1A. The communication section 53 transmits data supplied from the control section 51 to the information processing apparatus 100 or supplies data received from the information processing apparatus 100 to the control section 51. Note that data received by the communication section 53 from the information processing apparatus 100 can include a prompt generated by the information processing apparatus 100. Data provided by the communication section 53 to the information processing apparatus 100 can include a generation sentence which has been generated by a language model (described later) based on the prompt.

The storage section 52 stores a language model LM. For example, the storage section 52 stores a plurality of parameters that define the language model LM. These parameters are, for example, parameters which have been trained in advance by machine learning (i.e., parameters which have undergone an updating process by machine learning). Note, however, that the present example embodiment is not limited thereto.

The control section 51 executes the language model and thus acquires an output result by the language model LM. For example, the control section 51 inputs, into the language model LM, a prompt received from the information processing apparatus 100, and acquires a generation sentence generated by the language model LM. Moreover, the control section 51 provides the generation sentence to the information processing apparatus 100 via the communication section 53.

In the present example embodiment, the generation apparatus 50 is exemplified as an apparatus separated from the information processing apparatus 100. Note, however, that the present example embodiment is not limited thereto. It is possible to employ a configuration in which a control section of the information processing apparatus 100 has the function as the control section 51 included in the generation apparatus 50 or as a language model execution section in the control section 51. Similarly, it is possible to employ a configuration in which a storage section of the information processing apparatus 100 stores the language model LM stored in the storage section 52 included in the generation apparatus 50, and the language model LM can be executed by the information processing apparatus 100 itself.

### (Configuration of Information Processing Apparatus 100)

The following description will discuss a configuration of the information processing apparatus 100 in accordance with the present example embodiment, with reference to FIG. 3. As illustrated in FIG. 3, the information processing apparatus 100 includes a control section 10, a storage section 20, a communication section 30, and an input-output section 40.

### (Communication Section 30)

The communication section 30 communicates with an apparatus external to the information processing apparatus 100. For example, the communication section 30 communicates with the generation apparatus 50. The communication section 30 transmits data supplied from the control section 10 to the generation apparatus 50 or supplies data received from the generation apparatus 50 to the control section 10. Note that data transmitted by the communication section 30 to the generation apparatus 50 can include a prompt generated by the control section 10. Data received by the communication section 30 from the generation apparatus 50 can include a generation sentence generated by the generation apparatus 50 based on the prompt.

### (Input-Output Section 40)

The input-output section 40 is configured to include at least one of input-output apparatuses such as a keyboard, a mouse, a display, a printer, a touch panel, and the like. Alternatively, it is possible to employ a configuration in which input-output apparatuses such as a keyboard, a mouse, a display, a printer, and a touch panel are connected to the input-output section 40. In the case of such a configuration, the input-output section 40 receives input of various kinds of information with respect to the information processing apparatus 100 from the connected input apparatus. Moreover, the input-output section 40 outputs various kinds of information to the connected output apparatus under control of the control section 10. Examples of the input-output section 40 include interfaces such as a universal serial bus (USB).

### (Storage Section 20)

The storage section 20 stores various kinds of data referred to by the control section 10 and various kinds of data generated by the control section 10. For example, the storage section 20 stores:
a user instruction IN which has been acquired by the acquisition section 110 via the input-output section 40 or the communication section 30;
input data IND which has been acquired by the acquisition section 110 via the input-output section 40 or the communication section 30;
instruction content INC which has been generated by the generation section 12 with reference to at least one selected from the group consisting of the user instruction IN and the input data IND;
reference information RI which has been acquired by the acquisition section 110 via the input-output section 40 or the communication section 30;
a prompt PR which has been generated by the control section 10 with reference to the instruction content INC and the reference information RI;
a generation sentence GS which has been generated by the generation apparatus 50 based on the prompt PR; and
a plurality of industry-type-specific models SM. The specific descriptions pertaining to various kinds of data stored in the storage section 20 will be described later.

### (Control Section 10)

As illustrated in FIG. 3, the control section 10 includes a first acquisition section 11, a second acquisition section 13, and a generation section 12, as with in the first example embodiment. In the present example embodiment, the first acquisition section 11 and the second acquisition section 13 are correctively referred to also as an acquisition section 110.

### (First Acquisition Section 11)

The first acquisition section 11 acquires a user instruction IN via the input-output section 40 or the communication section 30, and causes the storage section 20 to store the acquired user instruction IN. The user instruction IN can include, for example, wording which suggests what kind of process is requested to be carried out with respect to what kind of input data. The user instruction acquired by the first acquisition section 11 is referred to by the generation section 12 (described later).

The first acquisition section 11 acquires input data IND in association with the user instruction IN. The first acquisition section 11 may acquire the input data IND together with the user instruction IN via the input-output section 40 or the communication section 30. Alternatively, it is possible to employ a configuration in which the first acquisition section 11 identifies, with reference to the acquired user instruction IN, input data to be used for carrying out a process based on the user instruction IN and acquires the identified input data IND from the storage section 20.

The first acquisition section 11 identifies instruction content INC with reference to at least one selected from the group consisting of the user instruction IN and the input data IND. For example, the first acquisition section 11 identifies, as the instruction content INC, content which includes both the user instruction IN and the input data IND.

The first acquisition section 11 acquires reference information RI which is to be referred to in a process indicated by the instruction content INC. Here, as described in the first example embodiment, the reference information RI can be, for example, information selected such that accuracy of a generation sentence is improved which is generated by a language model with reference to a prompt generated by the generation section 12 (described later). Note, however, that the present example embodiment is not limited to this. Specific content of the instruction content INC and the reference information RI does also not limit the present example embodiment. For example, it is possible to employ a configuration in which: the instruction content INC includes an instruction to evaluate an evaluation target; and the reference information RI includes past evaluation information which indicates evaluation in the past pertaining to the evaluation target. Here, the evaluation target may be or may not be configured to include at least a part of the input data IND described above.

### (Generation Section 12)

The generation section 12 generates a prompt with reference to the instruction content INC and the reference information RI which have been acquired (identified) by the first acquisition section 11. Here, the prompt PR generated by the generation section 12 is a prompt to be input into a language model LM executed by the generation apparatus 50. A specific configuration of the prompt generated by the generation section 12 does not limit the present example embodiment. For example, it is possible to employ a configuration in which the generation section 12 generates a prompt PR including the instruction content INC and the reference information RI.

For example, it is possible to employ a configuration in which the generation section 12 divides the evaluation target into a plurality of parts, and includes, in a prompt PR, evaluation targets for the respective parts. In the division process or the prompt generation process including the division process, the generation section 12 may use a language model (hereinafter referred to as “industry-type-specific model”) SM which has been trained for each work category.

Examples of the industry-type-specific model SM can include:
a first industry-type-specific model SM1 which has been trained by machine learning specific to a first industry type (first work category);
a second industry-type-specific model SM2 which has been trained by machine learning specific to a second industry type (second work category);
a third industry-type-specific model SM3 which has been trained by machine learning specific to a third industry type (third work category); and the like. More specifically, the industry-type-specific model SM can include:
a publishing industry mail-specific model SM1 which has been trained by training data including a plurality of pieces of mail in the publishing industry;
a financial industry-specific model SM2 which has been trained by training data including a plurality of contracts or financing-related documents in the financial industry;
a general industry estimate-specific model SM3 which has been trained by training data including a plurality of estimates in other general industries; and the like. The generation section 12 can be, for example, configured to: identify a work category of a target with reference to the user instruction IN acquired by the first acquisition section 11; and carry out the prompt generation process with use of an industry-type-specific model which has been trained specifically to the identified work category. Note, however, that the present example embodiment is not limited to these examples.

The prompt PR generated by the generation section 12 is provided to the generation apparatus 50 via, for example, the communication section 30, and the generation apparatus 50 generates a generation sentence GS based on the prompt PR with use of the language model LM.

### (Second Acquisition Section 13)

The second acquisition section 13 acquires, via, for example, the communication section 30, a generation sentence GS which has been generated by the language model LM based on the prompt PR. The acquired generation sentence GS is, for example, stored in the storage section 20.

### (Processing Example 1 by Information Processing Apparatus 100)

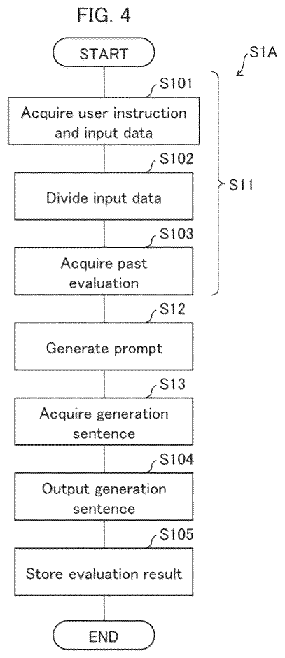

The following description will discuss processing example 1 carried out by the information processing apparatus 100 in accordance with the present example embodiment, with reference to FIG. 4. FIG. 4 is a flowchart illustrating a flow of processing example 1 (referred to also as an information processing method S1A) carried out by the information processing apparatus 100.

### (Step S101)

In step S101, the first acquisition section 11 acquires a user instruction IN and input data IND. For example, the first acquisition section 11 may acquire:
an instruction “evaluate the business continuity of a certain company” as the user instruction IN; and
at least a part of a business continuity plan sheet of the certain company as the input data IND. Note, however, that this example does not limit the present example embodiment, and the first acquisition section 11 may be configured to acquire an arbitrary user instruction IN and an arbitrary document corresponding to the user instruction IN in this step. Note that the certain company and the business continuity plan sheet can be expressed as evaluation targets to be evaluated by the information processing apparatus 100. It is possible to employ a configuration in which the first acquisition section 11 acquires, as input data IND, also templates or a part of templates of those target documents.

In this step, the first acquisition section 11 identifies (acquires) instruction content INC with reference to at least one selected from the group consisting of the user instruction IN and the input data IND. For example, the first acquisition section 11 identifies, as the instruction content INC, content which includes both the user instruction IN and the input data IND.

### (Step S102)

In step S102, the first acquisition section 11 carries out a process of dividing the input data IND which has been acquired in step S101 into a plurality of parts (elements). For example, the first acquisition section 11 may divide a plurality of sentences or paragraphs included in the input data IND into a plurality of parts for respective subjects or viewpoints.

The first acquisition section 11 may carry out the division process with use of an industry-type-specific model SM which has been trained specifically to a work category identified with reference to the user instruction IN. As described above, the industry-type-specific model is a model which has been trained specifically to each work category. Therefore, by using the industry-type-specific model, division of input data IND can be accurately carried out. Note that it is possible to employ a configuration in which the generation section 12 carries out the process of this step.

### (Step S103)

In step S103, the first acquisition section 11 acquires reference information RI. Here, in this step, as the reference information RI acquired by the first acquisition section 11, it is possible to use, for example, information selected such that accuracy of a generation sentence is improved which is generated by a language model with reference to a prompt generated by the generation section 12 (described later). The reference information RI acquired by the first acquisition section 11 in this step S103 is, for example, evaluation in the past pertaining to an evaluation target (the above-described “certain company” or “business continuity plan sheet of the certain company”).

The processes in steps S101 through S103 described above are processes corresponding to step S11 described in the first example embodiment.

### (Step S12)

Subsequently, in step S12, the generation section 12 generates a prompt PR with reference to the instruction content INC acquired in step S101 and the reference information RI acquired in step S103. For example, the generation section 12 generates a prompt PR including the instruction content INC and the reference information RI.

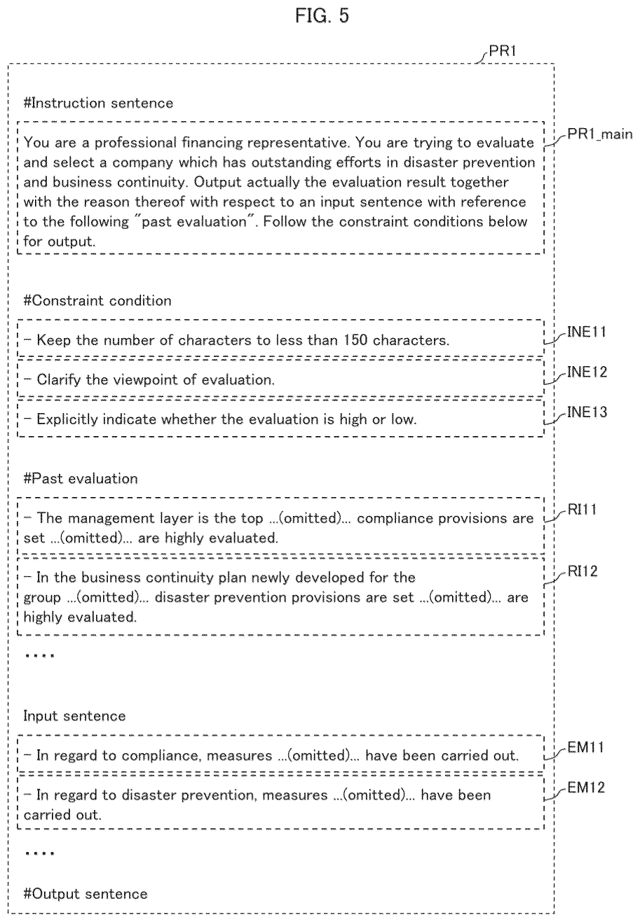

FIG. 5 is a diagram illustrating a prompt PR1 which is an example of a prompt PR generated by the generation section 12 in this step. As illustrated in FIG. 5, the prompt PR1 generated by the generation section 12 includes:
a tag indicating an instruction sentence (#instruction sentence);
content of an instruction sentence (PR1_main);
a tag indicating a constraint condition (#constraint condition);
content of a constraint condition (INE11 through INE13);
a tag indicating past evaluation (#past evaluation);
content of past evaluation (RI11 and RI12);
a tag indicating an input sentence (#input sentence);
content of an input sentence (EM11 and EM12); and
a tag indicating an output sentence (#output sentence). Here, the content of an instruction sentence (PR1_main), the content of a constraint condition (INE11 through INE13), and the content of an input sentence (EM11 and EM12), for example, express, as elements of the prompt PR1, pieces of information included in the instruction content INC described above.

More specifically, the content of an instruction sentence (PR1_main) is content generated by the generation section 12 in accordance with the user instruction IN acquired by the first acquisition section 11 in step S101. In the example illustrated in FIG. 5, the content of an instruction sentence (PR1_main) includes an instruction sentence “You are a professional financing representative. You are trying to evaluate and select a company which has outstanding efforts in disaster prevention and business continuity. Output actually the evaluation result together with the reason thereof with respect to an input sentence with reference to the following “past evaluation”. Follow the constraint conditions below for output.”, which corresponds to the user instruction IN “Evaluate the business continuity of a certain company” acquired in step S101.

Meanwhile, the content of a constraint condition (INE11 through INE13) is, for example, content generated by the generation section 12 based on information included in the user instruction IN acquired by the first acquisition section 11 in step S101. In the example illustrated in FIG. 5, the generation section 12 uses, as content of a constraint condition, instruction elements:
INE11: keep the number of characters to less than 150 characters;
INE12: clarify the viewpoint of evaluation; and
INE13: explicitly indicate whether the evaluation is high or low, which have been generated with reference to the user instructions IN. Note, however, that this example does not limit the present example embodiment, and predetermined content may be used as the content of a constraint condition (INE11 through INE13).

The content of an input sentence (EM11 and EM12) indicates input data IND which has been acquired by the first acquisition section 11 in step S101 and divided in step S102. More specifically, the content of an input sentence (EM11 and EM12) includes an element EM11 and an element EM12 of an input sentence obtained by dividing the input data IND.

Here, the element EM11 is, for example, an element which has been divided from the input data IND with use of the industry-type-specific model SM in step S102, and is an element for which a subject or viewpoint is “compliance”. Meanwhile, the element EM12 is, similarly, an element which has been divided from the input data IND with use of the industry-type-specific model SM in step S102, and is an element for which a subject or viewpoint is “disaster prevention”.

The content of past evaluation (RI11 and RI12) is an example of the reference information RI which has been acquired by the first acquisition section 11 in step S103. In other words, the reference information RI includes past evaluation information which indicates evaluation in the past pertaining to the evaluation target. Here, in this example, the generation section 12 may be configured to: divide the reference information RI so as to correspond to respective elements (or subjects or viewpoints) of the input data IND which has been divided in step S102; and include, in a prompt PR, the elements of the reference information RI which have been obtained by division in association with the respective elements of the input data IND. As such, it is possible to employ a configuration in which the generation section 12 divides the evaluation target (input data IND) into a plurality of parts, and includes, in a prompt PR, evaluation targets for the respective parts. Here, the industry-type-specific model described above may be used in the process of dividing the reference information RI. The industry-type-specific model is a model which has been trained specifically to each work category. Therefore, by using the industry-type-specific model, division of reference information RI can be accurately carried out.

In the example illustrated in FIG. 5, more specifically, the reference information RI (past evaluation) is divided into the elements RI11 and RI12 so as to correspond respectively to the elements EM11 and EM12 of the input data IND, and a prompt PR including the elements RI11 and RI12 obtained by the division is generated.

In this step, the generation section 12 may generate a prompt PR by applying:
content of an instruction sentence (PR1_main);
content of a constraint condition (INE11 through INE13);
past evaluation (RI11 and RI12); and
content of an input sentence (EM11 and EM12), which have been described above, to a predetermined prompt template. For example, the generation section 12 may generate a prompt PR by applying the content of an instruction sentence (PR1_main), the content of a constraint condition (INE11 through INE13), the past evaluation (RI11 and RI12), and the content of an input sentence (EM11 and EM12) described above to a prompt template including:
a tag indicating an instruction sentence (#instruction sentence);
a tag indicating a constraint condition (#constraint condition);
a tag indicating past evaluation (#past evaluation); and
a tag indicating an input sentence (#input sentence).

The prompt PR generated in this step is provided to the generation apparatus 50 via, for example, the communication section 30. Then, in the generation apparatus 50, the prompt is input into the language model LM, and the language model LM generates a generation sentence based on the prompt.

The control section 10 may be or may not be configured to present the generated prompt PR to a user via the input-output section 40.

### (Step S13)

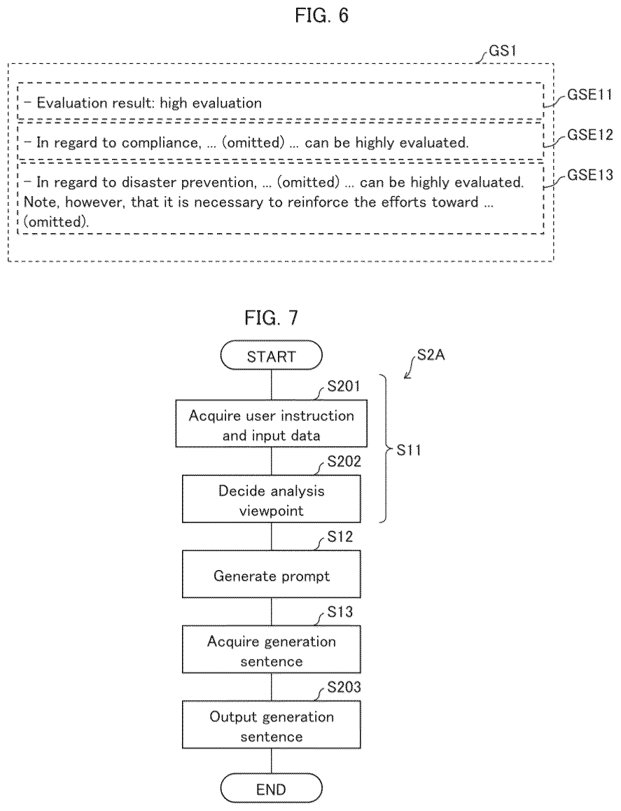

Subsequently, in step S13, the second acquisition section 13 acquires the generation sentence GS which has been generated by the language model LM based on the prompt PR generated in step S12. FIG. 6 illustrates a generation sentence GS1, which is an example of the generation sentence GS acquired by the second acquisition section 13 in this step.

In the example indicated FIG. 6, the generation sentence GS1 includes elements GSE11 through GSE13. Here, in the example, the element GSE11 indicates an evaluation result of the evaluation target (in the example of FIG. 6, “Evaluation result: high evaluation”). Meanwhile, the elements GSE12 and GSE13 indicate, for each subject or viewpoint, the basis for generating the evaluation result, the reason, the matters to be noted in the evaluation, and the like.

For example, the element GSE11 “In regard to compliance, . . . (omitted) . . . can be highly evaluated” indicates an evaluation reason from the viewpoint of “compliance”. The element GSE12 “In regard to disaster prevention, . . . (omitted) . . . can be highly evaluated. Note, however, that it is necessary to reinforce the efforts toward . . . (omitted)” indicates, together with matters to be noted, an evaluation reason from the viewpoint of “disaster prevention”. Thus, the generation sentence GS1 includes an evaluation result pertaining to the evaluation target, the evaluation result being obtained from one or more viewpoints decided with reference to the past evaluation information.

### (Step S104)

Subsequently, in step S104, the control section 10, for example, outputs the generation sentence GS as data which has been acquired in step S13 or presents the generation sentence GS to a user via the input-output section 40.

### (Step S105)

Subsequently, in step S105, at least one of the following items is stored in the storage section 20:
an evaluation result indicated by the generation sentence GS acquired in step S13; and
an evaluation result obtained by revising, by the user, the evaluation result indicated by the generation sentence GS acquired in step S13.

These evaluation results are accumulated in the storage section 20, and are acquired in step S103 described above as reference information in evaluating a new evaluation result.

The information processing apparatus 100 in accordance with this example brings about an example advantage similar to that of the information processing apparatus 1 in accordance with the first example embodiment. In the information processing apparatus 100 in accordance with this example: the reference information RI includes past evaluation information (RI11 and RI12) which indicates evaluation in the past pertaining to an evaluation target (input data IND); and the generation sentence GS includes evaluation results (GSE12 and GSE13) pertaining to the evaluation target, the evaluation results (GSE12 and GSE13) being obtained from one or more viewpoints decided with reference to the past evaluation information.

Therefore, according to the information processing apparatus 100 in accordance with this example, it is possible to acquire an evaluation result having high accuracy.

(Additional Remark Pertaining to this Processing Example 1)

In this processing example 1, the process may be carried out as follows:
the division process described in step S102 is carried out in advance with respect to a plurality of candidates for input data IND; and
in step S102, an element corresponding to the input data IND acquired in step S101 is selected from a plurality of elements which have been divided in advance in the division process.

Such a configuration corresponds to carrying out the process in step S102 as preprocessing prior to step S101.

### (Processing Example 2 by Information Processing Apparatus 100)

The following description will discuss processing example 2 carried out by the information processing apparatus 100 in accordance with the present example embodiment, with reference to FIG. 7. FIG. 7 is a flowchart illustrating a flow of processing example 2 (referred to also as an information processing method S2A) carried out by the information processing apparatus 100.

### (Step S201)

In step S201, the first acquisition section 11 acquires a user instruction IN and input data IND. For example, the first acquisition section 11 may acquire:
an instruction “carry out risk analysis of a certain company” as the user instruction IN; and
at least a part of a business plan sheet or securities report of the certain company as the input data IND. Note, however, that this example does not limit the present example embodiment, and the first acquisition section 11 may be configured to acquire an arbitrary user instruction IN and an arbitrary document corresponding to the user instruction IN in this step. Note that the certain company, the business plan sheet, and the securities report can be expressed as analysis targets to be analyzed by the information processing apparatus 100. It is possible to employ a configuration in which the first acquisition section 11 acquires, as input data IND, also templates or a part of templates of those target documents.

In this step, the first acquisition section 11 identifies instruction content INC with reference to at least one selected from the group consisting of the user instruction IN and the input data IND. For example, the first acquisition section 11 identifies, as the instruction content INC, content which includes both the user instruction IN and the input data IND.

### (Step S202)

In step S202, the generation section 12 decides an analysis viewpoint in the analysis. For example, it is possible to employ a configuration in which the generation section 12 decides an analysis viewpoint with reference to the user instruction IN and the input data IND which have been acquired in step S201. It is possible to employ a configuration in which the generation section 12 uses one or more predetermined analysis viewpoints. The generation section 12 may be configured to select, from a plurality of predetermined candidates for analysis viewpoints, one or more analysis viewpoints in the analysis with reference to the user instruction IN and the input data IND acquired in step S201.

As such, it is possible to employ a configuration in which: the first acquisition section 11 acquires information (referred to also as second type viewpoint information) indicating one or more analysis viewpoints intended by a user in the analysis process; and the generation section 12 decides viewpoint information (referred to also as first type viewpoint information) to be included in a prompt PR2 (described later) with reference to the second type viewpoint information.

For example, the generation section 12 decides “credit risk” and “operation risk” as analysis viewpoints in the analysis. Note that in the present specification, the term “operation risk” is sometimes referred to also as “ope-risk”. The analysis viewpoints decided in this step constitute an example of the reference information RI in this example.

The processes in steps S201 and S202 described above are processes corresponding to step S11 described in the first example embodiment.

### (Step S12)

Subsequently, in step S12, the generation section 12 generates a prompt PR with reference to the instruction content INC acquired in step S201 and the reference information RI acquired in step S202. For example, the generation section 12 generates a prompt PR including the instruction content INC and the reference information RI.

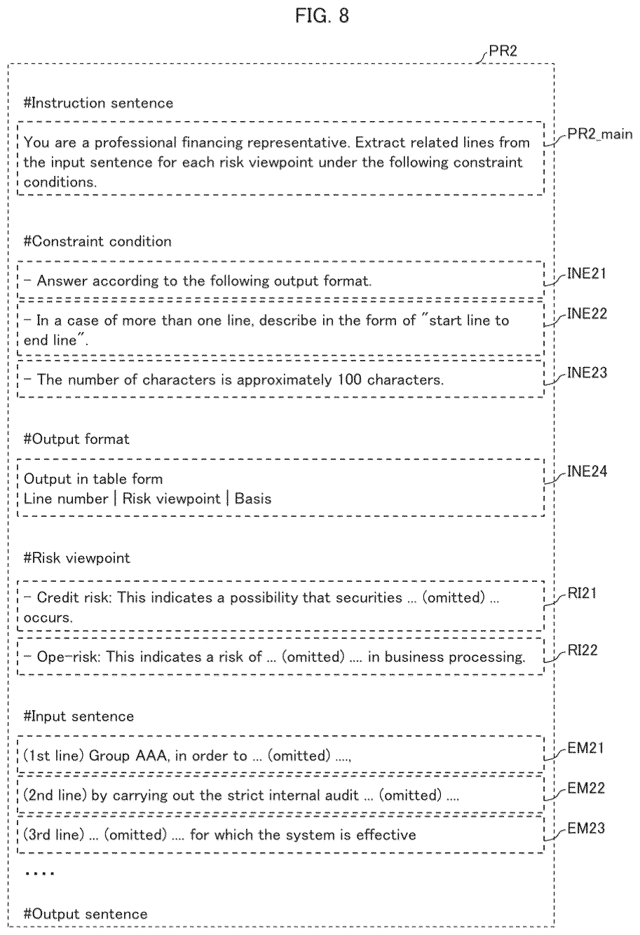

FIG. 8 is a diagram illustrating a prompt PR2 which is an example of a prompt PR generated by the generation section 12 in this step. As illustrated in FIG. 8, the prompt PR2 generated by the generation section 12 includes:
a tag indicating an instruction sentence (#instruction sentence);
content of an instruction sentence (PR2_main);
a tag indicating a constraint condition (#constraint condition);
content of a constraint condition (INE21 through INE23);
a tag indicating an output format (#output format);
content of an output format (INE24);
a tag indicating a risk viewpoint (#risk viewpoint);
content of a risk viewpoint (RI21 and RI22);
a tag indicating an input sentence (#input sentence);
content of an input sentence (EM21 through EM23); and
a tag indicating an output sentence (#output sentence). Here, the content of an instruction sentence (PR2_main), the content of a constraint condition (INE21 through INE23), and the content of an input sentence (EM21 through EM23), for example, express, as elements of the prompt PR2, pieces of information included in the instruction content INC described above.

More specifically, the content of an instruction sentence (PR2_main) is content generated by the generation section 12 in accordance with the user instruction IN acquired by the first acquisition section 11 in step S201. In the example illustrated in FIG. 8, the content of an instruction sentence (PR2_main) includes an instruction sentence “You are a professional financing representative. Extract related lines from the input sentence for each risk viewpoint under the following constraint conditions.”, which corresponds to the user instruction IN “Carry out risk analysis of a certain company” acquired in step S201.

Meanwhile, the content of a constraint condition (INE21 through INE23) is, for example, content generated by the generation section 12 based on information included in the user instruction IN acquired by the first acquisition section 11 in step S201. In the example illustrated in FIG. 8, the generation section 12 uses, as content of a constraint condition, instruction elements:
INE21: answer according to the following output format;
INE12: in a case of more than one line, describe in the form of “start line to end line”; and
INE13: the number of characters is approximately 100 characters, which have been generated with reference to the user instructions IN. Note, however, that this example does not limit the present example embodiment, and predetermined content may be used as the content of a constraint condition (INE21 through INE23).

The content of an output format (INE24) is content which defines a format of a generation sentence GS which is generated with reference to the prompt PR2. In this example, the following items are included as the content of an output format (INE24):
wording such as “output in table form” which designates a table form as an output form; and also
wording such as “line number|risk viewpoint|basis” which includes designation of items in rows or columns of the table form.

The content of a risk viewpoint (RI21 and RI22) is an example of the reference information RI (in this example, an analysis viewpoint) acquired by the first acquisition section 11 in step S202. In other words, the reference information RI includes information (referred to also as first type viewpoint information) indicating one or more analysis viewpoints in an analysis process.

In the example illustrated in FIG. 8, the content of a risk viewpoint (RI21 and RI22) includes, for example: wording indicating two analysis viewpoints, i.e., a credit risk and an ope-risk; and content indicating descriptions or definitions pertaining to those risks. More specifically, the following items are included.
Credit risk: This indicates a possibility that securities . . . (omitted) . . . occurs.
Ope-risk: This indicates a risk of . . . (omitted) . . . in business processing.
   As such, the reference information RI in this example includes, in addition to one or more analysis viewpoints, content pertaining to descriptions or definitions of the viewpoints. Therefore, it is possible to generate a generation sentence GS having high accuracy by the language model LM with reference to the reference information RI.

The content of an input sentence (EM21 through EM23) indicates input data IND which has been acquired by the first acquisition section 11 in step S101. For example, the content of an input sentence (EM21 through EM23) includes: an element EM21 which is an element (sentence) of the 1st line; an element EM22 which is an element (sentence) of the 2nd line; an element EM23 which is an element (sentence) of the 3rd line; and the like included in the input data IND.

In this step, the generation section 12 may generate a prompt PR by applying:
content of an instruction sentence (PR2_main);
content of a constraint condition (INE21 through INE23);
content of an output format (INE24);
content of a risk viewpoint (RI21 and RI22); and
content of an input sentence (EM21 through EM23), which have been described above, to a predetermined prompt template. For example, the generation section 12 may generate a prompt PR by applying the content of an instruction sentence (PR2_main), the content of a constraint condition (INE21 through INE23), the content of an output format (INE24), the content of a risk viewpoint (RI21 and RI22), and the content of an input sentence (EM21 through EM23) described above to a prompt template including:
a tag indicating an instruction sentence (#instruction sentence);
a tag indicating a constraint condition (#constraint condition);
a tag indicating an output format (#output format);
a tag indicating a risk viewpoint (#risk viewpoint); and
a tag indicating an input sentence (#input sentence).

The prompt PR generated in this step is provided to the generation apparatus 50 via, for example, the communication section 30. Then, in the generation apparatus 50, the prompt is input into the language model LM, and the language model LM generates a generation sentence based on the prompt.

The control section 10 may be or may not be configured to present the generated prompt PR to a user via the input-output section 40.

### (Step S13)

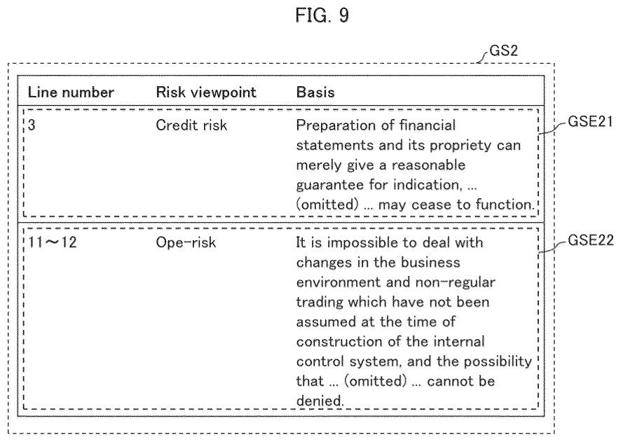

Subsequently, in step S13, the second acquisition section 13 acquires the generation sentence GS which has been generated by the language model LM based on the prompt PR generated in step S12. FIG. 9 illustrates a generation sentence GS2, which is an example of the generation sentence GS acquired by the second acquisition section 13 in this step.

In the example illustrated in FIG. 9, the generation sentence GS2 is configured in table form according to the content of the output format included in the prompt PR2 described above. The generation sentence GS2 includes elements GSE21 and GSE22 as elements in respective lines. Each of the elements includes a numeral indicating “line number”, a type of “risk viewpoint”, and “basis”. These items correspond to the content of the output format included in the prompt PR2 described above. Note that the above-described “risk viewpoint” indicates a “risk viewpoint” pertaining to a risk which has been determined to be present by the language model LM with reference to the prompt PR2 above.

More specifically, the element GSE21 indicates that it has been determined that a credit risk exists in the 3rd line of the input sentence. The element GSE21 includes, as a basis or description for the determination, a sentence “Preparation of financial statements and its propriety can merely give a reasonable guarantee for indication, . . . (omitted) . . . may cease to function.”

Meanwhile, the element GSE22 indicates that it has been determined that an ope-risk exists in the 11th and 12th lines of the input sentence. The element GSE22 includes, as a basis or description for the determination, a sentence “It is impossible to deal with changes in the business environment and non-regular trading which have not been assumed at the time of construction of the internal control system, and the possibility that . . . (omitted) . . . cannot be denied.”

As such, the generation sentence GS2 includes an analysis result pertaining to the analysis target, the analysis result being obtained from each of one or more viewpoints indicated by the first type viewpoint information.

### (Step S203)

Subsequently, in step S203, the control section 10, for example, outputs the generation sentence GS as data which has been acquired in step S13 or presents the generation sentence GS to a user via the input-output section 40.

The information processing apparatus 100 in accordance with this example brings about an example advantage similar to that of the information processing apparatus 1 in accordance with the first example embodiment. In the information processing apparatus 100 in accordance with this example: the reference information RI includes first type viewpoint information indicating one or more analysis viewpoints in an analysis process; and the generation sentence GS2 includes an analysis result pertaining to the analysis target, the analysis result being obtained from each of one or more viewpoints indicated by the first type viewpoint information.

Therefore, according to the information processing apparatus 100 in accordance with this example, it is possible to acquire an analysis result having high accuracy.

(Additional Remark Pertaining to this Processing Example 2)

In this processing example 2, it is possible to further carry out a process in which:
in step S12 described above, the generation section 12 includes, in the content of an input sentence (EM21, . . . ), one or more sentences which have a low relevance to or are unrelated to the content of the risk viewpoint;
in step S13 described above, it is determined, for the acquired generation sentence GS2, whether or not content having a low relevance to the content of the risk viewpoint is included; and
in a case where it has been determined that content having a low relevance to the content of the risk viewpoint is included in the generation sentence GS2, the composition of the prompt PR2 is changed, and then a generation sentence GS2 based on the changed prompt PR2 is acquired.

With such a configuration, it is possible to check whether or not the language model LM which has referred to the prompt PR2 is carrying out a process with high accuracy. Moreover, it is possible to ensure that the information processing apparatus 100 outputs a generation sentence GS2 having high accuracy.

It is possible to employ, for example, a configuration in which the industry-type-specific model described above is used in the determination process in step S13. The industry-type-specific model is a model which has been trained specifically to the work category. Therefore, by using the industry-type-specific model, it is possible to accurately eliminate output results having low accuracy by the language model LM.

### Processing Example 3 by Information Processing Apparatus 100

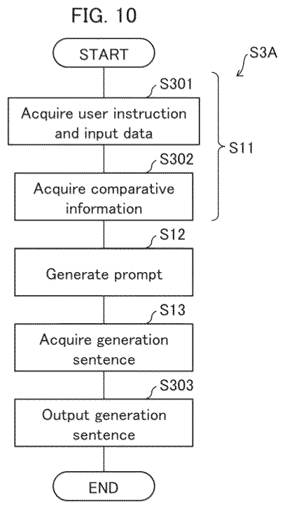

The following description will discuss processing example 3 carried out by the information processing apparatus 100 in accordance with the present example embodiment, with reference to FIG. 10. FIG. 10 is a flowchart illustrating a flow of processing example 3 (referred to also as an information processing method S3A) carried out by the information processing apparatus 100.

### (Step S301)

In step S301, the first acquisition section 11 acquires a user instruction IN and input data IND. For example, the first acquisition section 11 may acquire:
an instruction “check a certain document” as the user instruction IN; and
at least a part of the certain document as the input data IND. Here, a specific example of the above document does not limit the present example embodiment and may be, for example, an application document prepared by an applicant, a request for approval, or the like. The above document can be expressed as a check target to be checked by the information processing apparatus 100. It is possible to employ a configuration in which the first acquisition section 11 acquires, as input data IND, also a template or a part of template of the target document.

In this step, the first acquisition section 11 identifies instruction content INC with reference to at least one selected from the group consisting of the user instruction IN and the input data IND. For example, the first acquisition section 11 identifies, as the instruction content INC, content which includes both the user instruction IN and the input data IND.

### (Step S302)

In step S302, the generation section 12 acquires, in the checking, comparative information to be compared with the above document. Here, it is possible to employ a configuration in which the generation section 12 uses one or more pieces of predetermined comparative information. The generation section 12 may be configured to select, with reference to the user instruction IN and the input data IND acquired in step S301, one or more pieces of comparative information in the checking from a plurality of predetermined candidates for comparative information. The comparative information acquired in this step constitutes an example of the reference information RI in this example.

The processes in steps S301 and S302 described above are processes corresponding to step S11 described in the first example embodiment.

### (Step S12)

Subsequently, in step S12, the generation section 12 generates a prompt PR with reference to the instruction content INC acquired in step S301 and the reference information RI acquired in step S302. For example, the generation section 12 generates a prompt PR including the instruction content INC and the reference information RI.

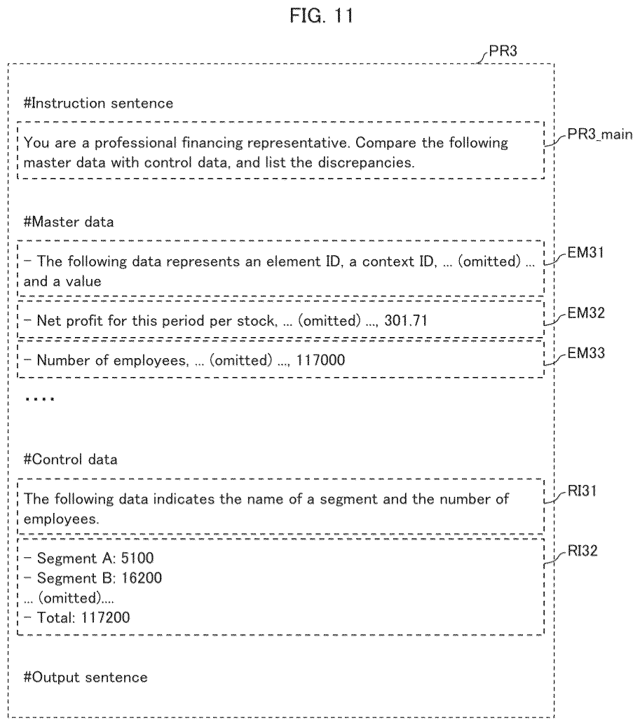

FIG. 11 is a diagram illustrating a prompt PR3 which is an example of a prompt PR generated by the generation section 12 in this step. As illustrated in FIG. 11, the prompt PR3 generated by the generation section 12 includes:
a tag indicating an instruction sentence (#instruction sentence);
content of an instruction sentence (PR3_main);
a tag indicating master data (#master data);
content of master data (EM31 through EM33);
a tag indicating control data (#control data);
content of control data (RI31 and RI32); and
a tag indicating an output sentence (#output sentence). Here, the content of an instruction sentence (PR3_main) and the content of master data (EM31 through EM33), for example, express, as elements of the prompt PR3, pieces of information included in the instruction content INC described above.

More specifically, the content of an instruction sentence (PR3_main) is content generated by the generation section 12 in accordance with the user instruction IN acquired by the first acquisition section 11 in step S301. In the example illustrated in FIG. 11, the content of an instruction sentence (PR3_main) includes an instruction sentence “You are a professional financing representative. Compare the following master data with control data, and list the discrepancies.”, which corresponds to the user instruction IN “Carry out checking of a certain document” acquired in step S301.

In the above example, the content of an instruction sentence (PR3_main) may be expressed to include “an instruction to include a point of difference in a generation sentence GS3 (described later) in a case where the check target (the certain document) is different from the comparative information (the control data)”.

The content of master data (EM31 through EM33) indicates input data IND which has been acquired by the first acquisition section 11 in step S101. For example, the content of master data (EM31 through EM33) includes “EM31: The following data represents an element ID, a context ID, . . . (omitted) . . . and a value” as definition sentences of constituent elements included in the master data (input data IND); as well as “EM32: Net profit for this period per stock, . . . (omitted) . . . , 301.71”; and “EM33: Number of employees, . . . (omitted) . . . , 117000” as specific numerical data for the constituent elements. In the above example, the master data is expressed in a data form corresponding to a comma separated values (CSV) form. Note, however, that the present example is not limited thereto. As described above, by including definition sentences of the constituent elements included in the master data in the content of the master data, it is possible to suitably use any data form as master data.

The content of control data (RI31 and RI32) is an example of the reference information RI (comparative information in this example) which has been acquired by the first acquisition section 11 in step S302. In other words, the reference information RI includes comparative information which is to be compared with the check target in a checking process.

In the example illustrated in FIG. 11, the content of control data (RI31 and RI32) includes: “RI31: The following data indicates the name of a segment and the number of employees” as definition sentences of constituent elements included in the control data; as well as “Segment A: 5100”; “Segment B: 16200”; . . . (omitted) . . . ; and “Total: 117200” as specific numerical data for the constituent elements. In the above example, the control data is also expressed in a data form corresponding to the CSV form. Note, however, that the present example is not limited thereto. As described above, by including definition sentences of the constituent elements included in the control data in the content of the control data, it is possible to suitably use any data form as control data.

In this step, the generation section 12 may generate a prompt PR by applying:
content of an instruction sentence (PR3_main);
content of master data (INE31 through INE33); and
content of control data (RI31 and RI32), which have been described above, to a predetermined prompt template. For example, the generation section 12 may generate a prompt PR by applying the content of an instruction sentence (PR3_main), the content of master data (INE31 through INE33), and the content of control data (RI31 and RI32) described above to a prompt template including:
a tag indicating an instruction sentence (#instruction sentence);
a tag indicating master data (#master data); and
a tag indicating control data (#control data).

The prompt PR generated in this step is provided to the generation apparatus 50 via, for example, the communication section 30. Then, in the generation apparatus 50, the prompt is input into the language model LM, and the language model LM generates a generation sentence based on the prompt.

The control section 10 may be or may not be configured to present the generated prompt PR to a user via the input-output section 40.

### (Step S13)

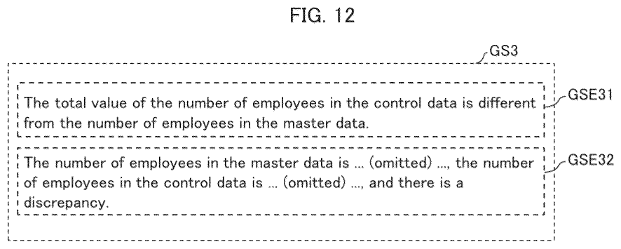

Subsequently, in step S13, the second acquisition section 13 acquires the generation sentence GS which has been generated by the language model LM based on the prompt PR generated in step S12. FIG. 12 illustrates a generation sentence GS3, which is an example of the generation sentence GS acquired by the second acquisition section 13 in this step.

In the example indicated FIG. 12, the generation sentence GS3 includes elements GSE31 and GSE32. The element GSE31 includes content indicating that the master data is different from the control data, and indicating items which are different between the master data and the control data. Specifically, the element GSE31 includes the content “the total value of the number of employees in the control data is different from the number of employees in the master data”. As such, the generation sentence GS3 includes information indicating a point of difference between the master data and the control data.

Meanwhile, the element GSE32 includes a description or a basis for the difference between the master data and the control data. For example, in the example illustrated in FIG. 12, the element GSE32 includes content “The number of employees in the master data is . . . (omitted) . . . , the number of employees in the control data is . . . (omitted) . . . , and there is a discrepancy.”

### (Step S303)

Subsequently, in step S303, the control section 10, for example, outputs the generation sentence GS as data which has been acquired in step S13 or presents the generation sentence GS to a user via the input-output section 40.

The information processing apparatus 100 in accordance with this example brings about an example advantage similar to that of the information processing apparatus 1 in accordance with the first example embodiment. In the information processing apparatus 100 in accordance with this example: the reference information RI includes comparative information which is to be compared with the check target in the checking process; the instruction content INC (e.g., the instruction sentence PR3_main) in the prompt PR3 includes an instruction to include a point of difference in the generation sentence in a case where the check target is different from the comparative information; and the generation sentence GS3 includes information indicating the point of difference.

Therefore, according to the information processing apparatus 100 in accordance with this example, it is possible to acquire a checking result having high accuracy.

### Third Example Embodiment

The following description will discuss a third example embodiment, which is an example of an embodiment of the present invention, in detail, with reference to the drawings. The same reference numerals are given to constituent elements having the same functions as those described in the foregoing example embodiments, and descriptions of such constituent elements are omitted as appropriate. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Information Processing System 1B)

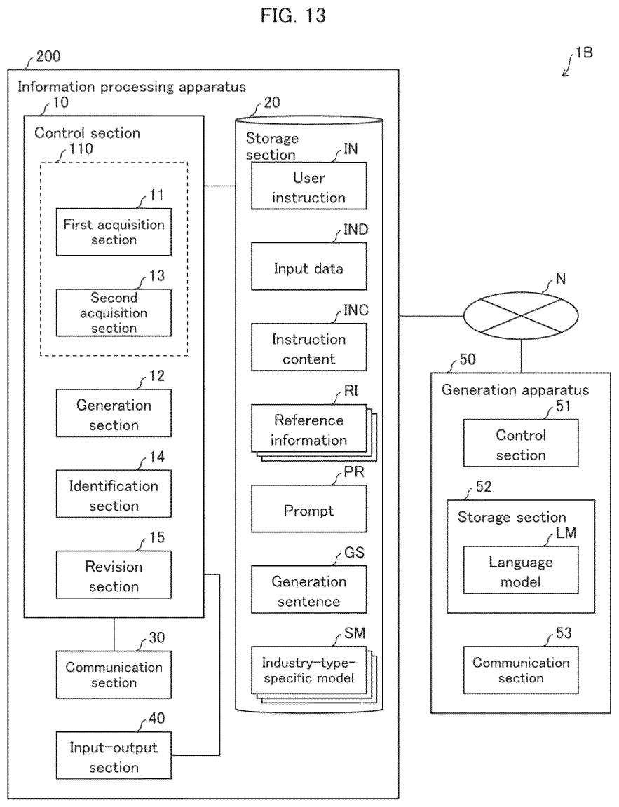

The following description will discuss a configuration of an information processing system 1B in accordance with the present example embodiment, with reference to FIG. 13. FIG. 13 is a block diagram illustrating the configuration of the information processing system 1B. As illustrated in FIG. 13, the information processing system 1B includes an information processing apparatus 200 and a generation apparatus 50 that is connected to the information processing apparatus 200 via a network N. A specific configuration of the network N does not limit the present example embodiment, and the network N is, for example, a wireless local area network (LAN), a wired LAN, a wide area network (WAN), a public network, a mobile data communication network, or a combination of these networks.

### (Generation Apparatus 50)

The generation apparatus 50 is similar to the content described in the second example embodiment, and therefore a description thereof is omitted here.

### (Information Processing Apparatus 200)

The information processing apparatus 200 in accordance with the present example embodiment includes an identification section 14 and a revision section 15 in addition to the constituent elements included in the information processing apparatus 100 in accordance with the second example embodiment. The following description will mainly discuss a point in which the information processing apparatus 200 is different from the information processing apparatus 100.

### (Identification Section 14)

The identification section 14 identifies a work category of a target, and provides, to the generation section 12, category information indicating the identified work category. For example, the identification section 14 identifies a work category of a target with reference to wording included in the user instruction IN acquired by the first acquisition section 11. Alternatively, it is possible to employ a configuration in which the identification section 14 acquires information indicating selection by a user in regard to a work category, and identifies a work category of a target with reference to the information.

Here, the term “work category” in the present example embodiment is intended to mean a category pertaining to at least one of, for example, industries and types of occupation (duties). For example, the work category can include categories corresponding respectively to the following plurality of industries:
publishing industry;
financial industry;
other general industries; and the like. Each of the categories can include, for example, subcategories which correspond respectively to the following plurality of types of occupation (duties):
mail preparation;
title proposal;
needs survey;
preparation of an estimate;
preparation of a contract;
legal check of a contract; and the like. Here, a certain subcategory may exist over a plurality of categories. For example, the subcategory “mail preparation” can exist in all categories of the publishing industry, the financial industry, and other general industries. In the present example embodiment, the wording “work category” can include the foregoing “industry category” and “type-of-occupation subcategory”. Note, however, that this does not limit the present example embodiment.

The identification section 14 may carry out a process of:
generating an industry-type-identifying prompt including the user instruction IN and an instruction sentence instructing identification of a work category of the user instruction IN;
inputting the generated industry-type-identifying prompt into a language model LM included in the generation apparatus 50; and
identifying a work category of the target with reference to output of the language model LM.

As another example, the identification section 14 may carry out a process of:
inputting the user instruction IN into a plurality of industry-type-specific models to identify a work category of a target with reference to output from each of the industry-type-specific models. As described above, the industry-type-specific model is a model which has been trained specifically to each work category. Therefore, by using the industry-type-specific model, a work category of the target can be accurately identified.

Alternatively, it is possible to employ a configuration in which the identification section 14 identifies a work category of a target with reference to a dictionary (keyword table) for each work category and depending on whether or not wording in the dictionary is included in the user instruction IN.

### (Generation Section 12)

In the process carried out by the generation section 12 in accordance with the second example embodiment, the generation section 12 in accordance with the present example embodiment refers to category information indicating the work category of the target. For example, in the generation process of generating a prompt PR in step S12 described above, the generation section 12 refers to category information indicating a work category of a target and generates a prompt PR corresponding to the work category of the target. For example, it is possible to carry out a process of: generating content of an instruction sentence included in the prompt PR so as to correspond to the work category of the target; extracting an element corresponding to the work category of the target from a plurality of elements (words, sentences, paragraphs, and the like) included in the input data IND, and using the extracted element for generation of the prompt PR (in this process, an industry-type-specific model specific to the work category of the target may be used); extracting an element corresponding to the work category of the target from a plurality of elements (words, sentences, paragraphs, and the like) included in the reference information RI, and using the extracted element for generation of the prompt PR (in this process, an industry-type-specific model specific to the work category of the target may be used); and the like. In the other processes described above, the generation section 12 may carry out a process corresponding to the work category of the target.

### (Revision Section 15)

The revision section 15 revises the generation sentence GS which has been generated by the generation apparatus 50. More specifically, the revision section 15 revises the generation sentence GS in accordance with the work category identified by the identification section 14. For example, it is possible to employ a configuration in which the revision section 15 revises the generation sentence GS with use of the industry-type-specific model SM described above.

For example, the revision section 15 may revise an expression which is included in the generation sentence GS and is inappropriate in the work category into an appropriate expression in the work category with use of an industry-type-specific model which has been trained specifically to the work category identified by the identification section 14. It is possible to employ a configuration in which the revised generation sentence RGS is, for example, provided to a user via the input-output section 40 or the communication section 30.

### (Flow of Information Processing Method S1B)

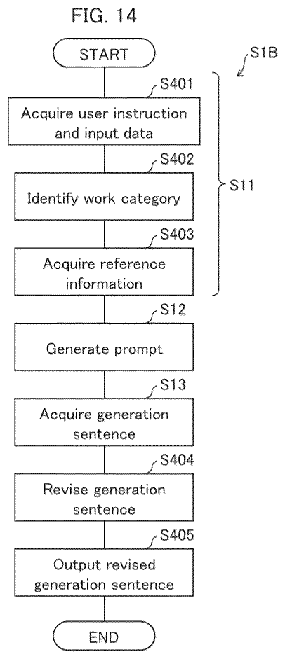

The following description will discuss a flow of an information processing method S1B in accordance with the present example embodiment, with reference to FIG. 14. FIG. 14 is a flowchart illustrating the flow of the information processing method S1B which is carried out by the information processing apparatus 200 in accordance with the present example embodiment.

### (Step S401)

In step S401, the first acquisition section 11 acquires a user instruction IN and input data IND. Then, the first acquisition section 11 identifies instruction content INC based on the user instruction IN and the input data IND. For example, in this step, the first acquisition section 11 carries out at least one of the processes of the foregoing steps S11, S101, S201, and S301.

### (Step S402)

In step S402, the identification section 14 identifies a work category of a target. For example, the identification section 14 identifies a work category of a target with reference to at least one selected from the group consisting of the user instruction IN and the input data IND acquired in step S401. The specific process by the identification section 14 is described above, and is therefore not repeatedly described here.

### (Step S403)

In step S403, the first acquisition section 11 acquires reference information RI. For example, in this step, the first acquisition section 11 carries out at least one of the processes of the foregoing steps S11, S103, S202, and S302. In this step, it is possible to employ a configuration in which the first acquisition section 11 selects and acquires one or more pieces of reference information RI from a plurality of candidates for reference information RI in accordance with the work category of the target.

Note that the above steps S401 through S403 are processes corresponding to step S11 described in the first example embodiment.

### (Step S12)

Subsequently, in step S12, the generation section 12 generates a prompt PR with reference to the instruction content INC acquired in step S401 and the reference information RI acquired in step S403. The process of the generation section 12 in this step includes a process similar to that in step S12 described above. In this step, the generation section 12 refers to the work category identified in step S402 and generates a prompt PR corresponding to the work category. For example, the generation section 12 may carry out a process of: generating content of an instruction sentence included in the prompt PR so as to correspond to the work category of the target; extracting an element corresponding to the work category of the target from a plurality of elements (words, sentences, paragraphs, and the like) included in the input data IND, and using the extracted element for generation of the prompt PR (in this process, an industry-type-specific model specific to the work category of the target may be used); extracting an element corresponding to the work category of the target from a plurality of elements (words, sentences, paragraphs, and the like) included in the reference information RI, and using the extracted element for generation of the prompt PR (in this process, an industry-type-specific model specific to the work category of the target may be used); and the like.

### (Step S13)

Subsequently, in step S13, the second acquisition section 13 acquires the generation sentence GS which has been generated by the language model LM based on the prompt PR generated in step S12. Examples of the generation sentence acquired in this step include the examples described in the foregoing example embodiments.

### (Step S404)

Subsequently, in step S404, the revision section 15 revises the generation sentence GS which has been acquired in step S13. For example, the revision section 15 revises the generation sentence GS in accordance with the work category which has been identified in step S402. For example, it is possible to employ a configuration in which the revision section 15 revises the generation sentence GS with use of the industry-type-specific model SM which has been trained specifically to the work category of the target identified in step S402. The specific process by the revision section 15 is described above, and is therefore not repeatedly described here.

The information processing apparatus 200 in accordance with this example brings about an example advantage similar to those of the information processing apparatuses 1 and 100 in accordance with the foregoing example embodiments. The information processing apparatus 200 in accordance with the present example embodiment includes the configuration of: identifying a work category of a target; generating a prompt PR corresponding to the identified work category; and revising, in accordance with the identified work category, the generation sentence GS generated based on the prompt. According to the configuration, it is possible to provide a work assistance technique having higher accuracy.

### Software Implementation Example

Some or all of the functions of the information processing apparatus (1, 100, 200) may be implemented by hardware such as an integrated circuit (IC chip), or may be implemented by software.

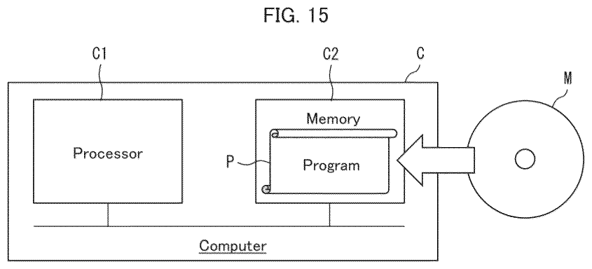

In the latter case, the information processing apparatus (1, 100, 200) is realized by, for example, a computer that executes instructions of a program that is software realizing the foregoing functions. FIG. 15 illustrates an example of such a computer (hereinafter, referred to as “computer C”). The computer C includes at least one processor C1 and at least one memory C2. The memory C2 stores a program P for causing the computer C to function as the information processing apparatus (1, 100, 200). The processor C1 of the computer C retrieves the program P from the memory C2 and executes the program P, so that the functions of the information processing apparatus (1, 100, 200) are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communication network, a broadcast wave, or the like. The computer C can obtain the program P also via such a transmission medium.

### [Additional Remark 1]

The present disclosure includes techniques described in supplementary notes below. Note, however, that the present invention is not limited to the techniques described in supplementary notes below, but may be altered in various ways by a skilled person within the scope of the claims.

### (Supplementary Note A1)

An information processing apparatus including: a first acquisition means for acquiring instruction content and reference information which is to be referred to in a process indicated by the instruction content; a generation means for generating a prompt with reference to the instruction content and the reference information; and a second acquisition means for acquiring a generation sentence which has been generated based on the prompt.

### (Supplementary Note A2)

The information processing apparatus according to supplementary note A1, in which: the generation means generates a prompt including the instruction content and the reference information.

### (Supplementary Note A3)

The information processing apparatus according to supplementary note A1 or A2, in which: the instruction content includes an instruction to evaluate an evaluation target; and the reference information includes past evaluation information which indicates evaluation in the past pertaining to the evaluation target.

### (Supplementary Note A4)

The information processing apparatus according to supplementary note A3, in which: the generation sentence includes an evaluation result pertaining to the evaluation target, the evaluation result being obtained from one or more viewpoints decided with reference to the past evaluation information.

### (Supplementary Note A5)

The information processing apparatus according to supplementary note A3 or A4, wherein: the generation means divides the evaluation target into a plurality of parts, and includes, in the prompt, evaluation targets for the respective plurality of parts.

### (Supplementary Note A6)

The information processing apparatus according to supplementary note A1 or A2, in which: the instruction content includes an instruction to analyze an analysis target; and the reference information includes first type viewpoint information indicating one or more analysis viewpoints in an analysis process.

### (Supplementary Note A7)

The information processing apparatus according to supplementary note A6, in which: the generation sentence includes an analysis result pertaining to the analysis target, the analysis result being obtained from each of one or more viewpoints indicated by the first type viewpoint information.

### (Supplementary Note A8)

The information processing apparatus according to supplementary note A6 or A7, in which: the first acquisition means acquires second type viewpoint information which indicates one or more analysis viewpoints intended by a user in the analysis process; and the generation means decides the first type viewpoint information with reference to the second type viewpoint information.

### (Supplementary Note A9)

The information processing apparatus according to supplementary note A1 or A2, in which: the instruction content includes an instruction to check a check target; and the reference information includes comparative information which is to be compared with the check target in a checking process.

### (Supplementary Note A10)

The information processing apparatus according to supplementary note A9, in which: in a case where the check target is different from the comparative information, the instruction content includes an instruction to include a point of difference in the generation sentence.

### (Supplementary Note A11)

The information processing apparatus according to supplementary note A10, in which: the generation sentence includes information indicating the point of difference.

### (Supplementary Note A12)

The information processing apparatus according to any one of supplementary notes A1 through A11, further including: an identification means for identifying a work category of a target, the generation means generating a prompt corresponding to the work category which has been identified by the identification means.

### (Supplementary Note A13)

The information processing apparatus according to supplementary note A12, further including: a revision means for revising the generation sentence in accordance with the work category which has been identified by the identification means.

### (Supplementary Note B1)

An information processing method, including: acquiring, by at least one processor, instruction content and reference information which is to be referred to in a process indicated by the instruction content; generating, by the at least one processor, a prompt with reference to the instruction content and the reference information; and acquiring, by the at least one processor, a generation sentence which has been generated based on the prompt.

### (Supplementary Note B2)

The information processing method according to supplementary note B1, in which: in the generating, a prompt including the instruction content and the reference information is generated.

### (Supplementary Note B3)

The information processing method according to supplementary note B1 or B2, in which: the instruction content includes an instruction to evaluate an evaluation target; and the reference information includes past evaluation information which indicates evaluation in the past pertaining to the evaluation target.

### (Supplementary Note B4)

The information processing method according to supplementary note B3, in which: the generation sentence includes an evaluation result pertaining to the evaluation target, the evaluation result being obtained from one or more viewpoints decided with reference to the past evaluation information.

### (Supplementary Note B5)

The information processing method according to supplementary note B3 or B4, wherein: in the generating, the evaluation target is divided into a plurality of parts, and evaluation targets for the respective plurality of parts are included in the prompt.

### (Supplementary Note B6)

The information processing method according to supplementary note B1 or B2, in which: the instruction content includes an instruction to analyze an analysis target; and the reference information includes first type viewpoint information indicating one or more analysis viewpoints in an analysis process.

### (Supplementary Note B7)

The information processing method according to supplementary note B6, in which: the generation sentence includes an analysis result pertaining to the analysis target, the analysis result being obtained from each of one or more viewpoints indicated by the first type viewpoint information.

### (Supplementary Note B8)

The information processing method according to supplementary note B6 or B7, in which: in the acquiring, second type viewpoint information is acquired which indicates one or more analysis viewpoints intended by a user in the analysis process; and in the generating, the first type viewpoint information is decided with reference to the second type viewpoint information.

### (Supplementary Note B9)

The information processing method according to supplementary note B1 or B2, in which: the instruction content includes an instruction to check a check target; and the reference information includes comparative information which is to be compared with the check target in a checking process.

### (Supplementary Note B10)

The information processing method according to supplementary note B9, in which: in a case where the check target is different from the comparative information, the instruction content includes an instruction to include a point of difference in the generation sentence.

### (Supplementary Note B11)

The information processing method according to supplementary note B10, in which: the generation sentence includes information indicating the point of difference.

### (Supplementary Note B12)

The information processing method according to any one of supplementary notes B1 through B11, further including: identifying a work category of a target, in the generating, a prompt corresponding to the work category which has been identified in the identifying being generated.

### (Supplementary Note B13)

The information processing method according to supplementary note B12, further including: revising the generation sentence in accordance with the work category which has been identified in the identifying.

### (Supplementary Note C1)

A program for causing a computer to carry out: a first acquisition process of acquiring instruction content and reference information which is to be referred to in a process indicated by the instruction content; a generation process of generating a prompt with reference to the instruction content and the reference information; and a second acquisition process of acquiring a generation sentence which has been generated based on the prompt.

### (Supplementary Note C2)

The program according to supplementary note C1, in which: in the generation process, a prompt including the instruction content and the reference information is generated.

### (Supplementary Note C3)

The program according to supplementary note C1 or C2, in which: the instruction content includes an instruction to evaluate an evaluation target; and the reference information includes past evaluation information which indicates evaluation in the past pertaining to the evaluation target.

### (Supplementary Note C4)

The program according to supplementary note C3, in which: the generation sentence includes an evaluation result pertaining to the evaluation target, the evaluation result being obtained from one or more viewpoints decided with reference to the past evaluation information.

### (Supplementary Note C5)

The program according to supplementary note C3 or C4, in which: in the generation process, the evaluation target is divided into a plurality of parts, and evaluation targets for the respective plurality of parts are included in the prompt.

### (Supplementary Note C6)

The program according to supplementary note C1 or C2, in which: the instruction content includes an instruction to analyze an analysis target; and the reference information includes first type viewpoint information indicating one or more analysis viewpoints in an analysis process.

### (Supplementary Note C7)

The program according to supplementary note C6, in which: the generation sentence includes an analysis result pertaining to the analysis target, the analysis result being obtained from each of one or more viewpoints indicated by the first type viewpoint information.

### (Supplementary Note C8)

The program according to supplementary note C6 or C7, in which: in the first acquisition process, second type viewpoint information is acquired which indicates one or more analysis viewpoints intended by a user in the analysis process; and in the generation process, the first type viewpoint information is decided with reference to the second type viewpoint information.

### (Supplementary Note C9)

The program according to supplementary note C1 or C2, in which: the instruction content includes an instruction to check a check target; and the reference information includes comparative information which is to be compared with the check target in a checking process.

### (Supplementary Note C10)

The program according to supplementary note C9, in which: in a case where the check target is different from the comparative information, the instruction content includes an instruction to include a point of difference in the generation sentence.

### (Supplementary Note C11)

The program according to supplementary note C10, in which: the generation sentence includes information indicating the point of difference.

### (Supplementary Note C12)

The program according to any one of supplementary notes C1 through C11, wherein: the computer is caused to further carry out an identification process of identifying a work category of a target; and in the generation process, a prompt corresponding to the work category which has been identified in the identification process is generated.

### (Supplementary Note C13)

The program according to supplementary note C12, in which: the computer is caused to further carry out a revision process of revising the generation sentence in accordance with the work category which has been identified in the identification process.

### [Additional Remark 2]

The present disclosure includes techniques described in supplementary notes below. Note, however, that the present invention is not limited to the techniques described in supplementary notes below, but may be altered in various ways by a skilled person within the scope of the claims.

### (Supplementary Note D1)

An information processing apparatus including at least one processor, the at least one processor carrying out: a first acquisition process of acquiring instruction content and reference information which is to be referred to in a process indicated by the instruction content; a generation process of generating a prompt with reference to the instruction content and the reference information; and a second acquisition process of acquiring a generation sentence which has been generated based on the prompt.

### (Supplementary Note D2)

The information processing apparatus according to supplementary note D1, in which: in the generation process, a prompt including the instruction content and the reference information is generated.

### (Supplementary Note D3)

The information processing apparatus according to supplementary note D1 or D2, in which: the instruction content includes an instruction to evaluate an evaluation target; and the reference information includes past evaluation information which indicates evaluation in the past pertaining to the evaluation target.

### (Supplementary Note D4)

The information processing apparatus according to supplementary note D3, in which: the generation sentence includes an evaluation result pertaining to the evaluation target, the evaluation result being obtained from one or more viewpoints decided with reference to the past evaluation information.

### (Supplementary Note D5)

The information processing apparatus according to supplementary note D3 or D4, in which: in the generation process, the evaluation target is divided into a plurality of parts, and evaluation targets for the respective plurality of parts are included in the prompt.

### (Supplementary Note D6)

The information processing apparatus according to supplementary note D1 or D2, in which: the instruction content includes an instruction to analyze an analysis target; and the reference information includes first type viewpoint information indicating one or more analysis viewpoints in an analysis process.

### (Supplementary Note D7)

The information processing apparatus according to supplementary note D6, in which: the generation sentence includes an analysis result pertaining to the analysis target, the analysis result being obtained from each of one or more viewpoints indicated by the first type viewpoint information.

### (Supplementary Note D8)

The information processing apparatus according to supplementary note D6 or D7, in which: in the first acquisition process, second type viewpoint information is acquired which indicates one or more analysis viewpoints intended by a user in the analysis process; and in the generation process, the first type viewpoint information is decided with reference to the second type viewpoint information.

### (Supplementary Note D9)

The information processing apparatus according to supplementary note D1 or D2, in which: the instruction content includes an instruction to check a check target; and the reference information includes comparative information which is to be compared with the check target in a checking process.

### (Supplementary Note D10)

The information processing apparatus according to supplementary note D9, in which: in a case where the check target is different from the comparative information, the instruction content includes an instruction to include a point of difference in the generation sentence.

### (Supplementary Note D11)

The information processing apparatus according to supplementary note D10, in which: the generation sentence includes information indicating the point of difference.

### (Supplementary Note D12)

The information processing apparatus according to any one of supplementary notes D1 through D11, in which: the at least one processor further carries out an identification process of identifying a work category of a target; and in the generation process, a prompt corresponding to the work category which has been identified in the identification process is generated.

### (Supplementary Note D13)

The information processing apparatus according to supplementary note D12, in which: the at least one processor further carries out a revision process of revising the generation sentence in accordance with the work category which has been identified in the identification process.

### REFERENCE SIGNS LIST

1, 100, 200: Information processing apparatus
11: First acquisition section (first acquisition means)
12: Generation section (generation means)
13: Second acquisition section (second acquisition means)
14: Identification section (identification means)
15: Revision section (revision means)

1. An information processing apparatus comprising at least one processor, the at least one processor carrying out:
a first acquisition process of acquiring instruction content and reference information which is to be referred to in a process indicated by the instruction content;
a generation process of generating a prompt with reference to the instruction content and the reference information; and
a second acquisition process of acquiring a generation sentence which has been generated based on the prompt.

2. The information processing apparatus according to claim 1, wherein:
in the generation process, the at least one processor generates a prompt including the instruction content and the reference information.

3. The information processing apparatus according to claim 2, wherein:
the instruction content includes an instruction to evaluate an evaluation target; and
the reference information includes past evaluation information which indicates evaluation in the past pertaining to the evaluation target.

4. The information processing apparatus according to claim 3, wherein:
the generation sentence includes an evaluation result pertaining to the evaluation target, the evaluation result being obtained from one or more viewpoints decided with reference to the past evaluation information.

5. The information processing apparatus according to claim 4, wherein:
in the generation process, the evaluation target is divided into a plurality of parts, and evaluation targets for the respective plurality of parts are included in the prompt.

6. The information processing apparatus according to claim 2, wherein:
the instruction content includes an instruction to analyze an analysis target; and
the reference information includes first type viewpoint information indicating one or more analysis viewpoints in an analysis process.

7. The information processing apparatus according to claim 6, wherein:
the generation sentence includes an analysis result pertaining to the analysis target, the analysis result being obtained from each of one or more viewpoints indicated by the first type viewpoint information.

8. The information processing apparatus according to claim 7, wherein:
in the first acquisition process, second type viewpoint information is acquired which indicates one or more analysis viewpoints intended by a user in the analysis process; and
in the generation process, the first type viewpoint information is decided with reference to the second type viewpoint information.

9. The information processing apparatus according to claim 2, wherein:
the instruction content includes an instruction to check a check target; and
the reference information includes comparative information which is to be compared with the check target in a checking process.

10. The information processing apparatus according to claim 9, wherein:
in a case where the check target is different from the comparative information, the instruction content includes an instruction to include a point of difference in the generation sentence.

11. The information processing apparatus according to claim 10, wherein:
the generation sentence includes information indicating the point of difference.

12. The information processing apparatus according to claim 1, wherein:
the at least one processor further carries out an identification process of identifying a work category of a target; and
in the generation process, the at least one processor generates a prompt corresponding to the work category which has been identified in the identification process.

13. The information processing apparatus according to claim 12, wherein:
the at least one processor further carries out a revision process of revising the generation sentence in accordance with the work category which has been identified in the identification process.

14. An information processing method, comprising:
acquiring, by at least one processor, instruction content and reference information which is to be referred to in a process indicated by the instruction content;
generating, by the at least one processor, a prompt with reference to the instruction content and the reference information; and
acquiring, by the at least one processor, a generation sentence which has been generated based on the prompt.

15. A non-transitory storage medium storing a program for causing a computer to carry out:
a first acquisition process of acquiring instruction content and reference information which is to be referred to in a process indicated by the instruction content;
a generation process of generating a prompt with reference to the instruction content and the reference information; and
a second acquisition process of acquiring a generation sentence which has been generated based on the prompt.
